(19) United States
(12) Patent Application Publication
(10) Pub. No.: US 2024/0424978 A1
(43) Pub. Date: Dec. 26, 2024

(54) METHOD FOR CONTROLLING HEADLIGHTS OF A MOTOR VEHICLE

(71) Applicant: HELLA GmbH & Co. KGaA, Lippstadt (DE)

(72) Inventors: Sebastian BARTSCHER, Hamm (DE); Tobias IRMSCHER, Lippstadt (DE); Rainer KAUSCHKE, Lippstadt (DE); Boris KUBITZA, Moehnesee-Koerbecke (DE); Heinz POLLMANN, Geseke (DE); Christian SMARSLIK, Muenster (DE); Udo VENKER, Guetersloh (DE); Carsten WILKS, Lippstadt (DE)

(73) Assignee: HELLA GmbH & Co. KGaA, Lippstadt (DE)

(21) Appl. No.: 18/829,157

(22) Filed: Sep. 9, 2024

Related U.S. Application Data
(63) Continuation of application No. PCT/EP2023/054545, filed on Feb. 23, 2023.

(30) Foreign Application Priority Data
Mar. 7, 2022 (DE) 10 2022 105 237.0

(51) Int. Cl. B60Q 1/14; H05B 47/115

(52) U.S. Cl. CPC B60Q 1/1423; H05B 47/115; B60Q 2300/054; B60Q 2300/112; B60Q 2300/40

(57) ABSTRACT

A method for controlling headlights of a motor vehicle. The headlights are operated in a low beam mode such that a low beam distribution is emitted by the headlights. An object is detected in front of the motor vehicle during operation in the low beam mode. An automatic reduction of a light intensity distribution is triggered exclusively in a region of the low beam distribution. the size and position of which depends on a distance of the motor vehicle from the object, on a position of the object and on a width of the object.

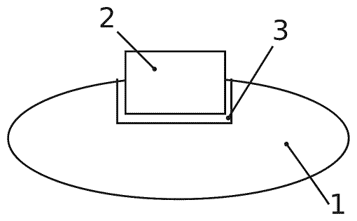

This nonprovisional application is a continuation of International Application No. PCT/EP2023/054545, which was filed on Feb. 23, 2023, and which claims priority to German Patent Application No. 10 2022 105 237.0, which was filed in Germany on Mar. 7, 2022, and which are both herein incorporated by reference.

### BACKGROUND OF THE INVENTION

### Field of the Invention

The present invention relates to a method for controlling headlights of a motor vehicle.

### Description of the Background Art

A method is known from DE 10 2011 007 181 A1 in which the light intensity radiating from the headlights is reduced as a function of the distance from a preceding motor vehicle.

### SUMMARY OF THE INVENTION

It is an object of the present invention to increase safety during operation of the motor vehicle.

In an example of the invention, the headlights are operated in a low beam mode so that a low beam distribution is emitted by the headlights. The low beam differs from the high beam, for example. The low beam distribution, in contrast to the high beam, is designed to reduce the risk of blinding other road users. For example, it is possible that in the low beam mode, the illuminance at a distance of 30 m in front of each individual headlight is not greater than 1 lx on a plane perpendicular to the roadway at the level of the center of the headlight and above.

During operation in the low beam mode, an object is detected in front of the motor vehicle. This may take place, for example, using sensors present in the motor vehicle, as known from the prior art. The object may, for example, be another motor vehicle or also a group of motor vehicles. The object may, for example, be positioned in a region that is captured by the low beam distribution. The detection of the object triggers an automatic reduction of a light intensity distribution solely in a region whose size and position are a function of a distance of the motor vehicle from the object, from a position of the object, and from a width of the object. Within the scope of the present description, the width is understood to mean in particular the extension of the object in a transverse direction in the coordinate system of the motor vehicle. The transverse direction may extend, for example, in a horizontal direction perpendicular to the longitudinal direction. The longitudinal direction may be the direction in which the motor vehicle is moved when used as intended, without a steering movement. When the object is another motor vehicle, the width may be the extension of the other motor vehicle in the transverse direction of the other motor vehicle.

Prior to the reduction, the light intensity distribution within the region may be homogeneous or may have a gradient.

The reduction of the light intensity distribution in the region is advantageous for reducing the likelihood of blinding the user of the motor vehicle, whose headlights are controlled, by light that is reflected by the object. Since the region is adapted to the position, the distance, and the width of the object, the light intensity distribution of the low beam distribution in other regions in which no reflection by the object takes place is not reduced, so that at that location good visibility conditions prevail for the user of the motor vehicle. The region therefore preferably includes only the object. For improved practicability, in practice the region may additionally include a tolerance portion at both sides around the object, next to and below the object. The tolerance portion has an extension that is much smaller than the width of the object. For example, the tolerance portion on both sides, next to the object and below the object, may have an extension that is less than one-fifth of the width of the object.

Thus, it is possible for the reduction of the light intensity distribution to be triggered, in an example, only when the distance of the object from the motor vehicle is less than a distance threshold value. This is advantageous, for example, since for relatively large distances no blinding of the user of the motor vehicle, whose headlights are controlled, yet occurs. The entire low beam distribution may then be used without reducing the light intensity somewhere, due to the object, to enable the best possible visibility for the user.

The distance threshold value may be 15 meters at most, preferably 10 meters at most.

The light intensity of the low beam distribution outside the region may be maintained simultaneously with the reduction of the light intensity distribution in the region. As a result, good visibility conditions may be achieved for the user of the motor vehicle outside the region.

It is possible for the reduction of the light intensity distribution to be triggered only when the motor vehicle is traveling at a speed below a speed threshold or is stationary. This is advantageous, since in particular at relatively low speeds or at a standstill, the distance between the motor vehicle and the object is so small that interfering reflections at the object may occur. Such low speeds may occur, for example, in city traffic or also in a traffic jam or in slow-moving traffic on a highway or freeway.

The low beam distribution may be designed as a city low beam distribution. The city low beam distribution may be designed, for example, for a wider illumination of the roadway compared to other low beam distributions. In addition, the city low beam distribution may have a smaller asymmetrical portion compared to other low beam distributions.

During the reduction of the light intensity distribution the light intensity may be set to a fixed value. This may mean, for example, that the light intensity is set to the fixed value independently of other parameters. A further change in the light intensity distribution takes place only when the light intensity distribution in the region is changed to the value that it had prior to the reduction.

During the reduction of the light intensity distribution the light intensity distribution may be controlled in the region as a function of a brightness that is determined in the region. The brightness in the region may be determined, for example, using sensors of the motor vehicle. This control is particularly advantageous in reducing the likelihood of blinding the user of the motor vehicle, and at the same time in providing the region with sufficiently bright illumination, since the determined brightness contains the reflections caused by the object. The light intensity distribution may preferably be reduced so greatly that the likelihood of blinding is decreased, but the light intensity distribution is still sufficient to allow recognition of as many details as possible in the region.

If automatically illuminating elements of the object, for example a brake light, a taillight, or a blinker light, are present in the region, the light intensity emitted by these elements may likewise contribute to the determined brightness in the region.

The object may include a group of multiple motor vehicles. In this case, the region may include multiple sections that are separate from one another. One motor vehicle from the group may then be situated in each of the sections.

The control unit can include an electronic digital memory medium and a digital signal processing unit, which may also be referred to as a processor, for example. Machine-readable instructions are stored in the memory medium. The digital signal processing unit is designed to read out and execute the instructions. In addition, the digital signal processing unit is designed, during execution of the instructions, to control the headlights by use of a method according to an example of the invention.

The motor vehicle can include a control unit according to an example of the invention, and the headlights.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which are given by way of illustration only, and thus, are not limitive of the present invention, and wherein the sole FIGURE shows a schematic view of a light distribution that is generated by use of a method according to an example the invention.

### DETAILED DESCRIPTION

A low beam distribution 1 is generated by operation of headlights of a motor vehicle in a low beam mode. As soon as an object 2 has been detected in front of the motor vehicle, the light intensity is automatically reduced in a region 3 of the low beam distribution. The region 3 is positioned in such a way that a portion of the object 2 is present therein. The position and the size of the region 3 are thus a function of the width of the object 2, the position of the object 2, and the distance between the motor vehicle and the object 2.

The region 3 preferably includes a tolerance portion at both sides of the object 2 and below the object 2. This may be advantageous in reducing the likelihood of the object 2 being positioned outside the region 3 and inside the low beam distribution 1 due to errors or relatively rapid movements or changes in movement.

Due to the positioning of the object 2 within the region 3 having the reduced light intensity, reflections from the surface of the object 2 to the user of the motor vehicle are reduced, thus lowering the risk of blinding for the user. It is therefore particularly advantageous when the light intensity in the region 3 is controlled as a function of a brightness that is detected in the region 3. The light intensity in the region 3 may thus be reduced so greatly that the likelihood of blinding is reduced, but the region 3 is still sufficiently strongly illuminated.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for controlling headlights of a motor vehicle, the method comprising:
operating the headlights in a low beam mode so that a low beam distribution is emitted by the headlights;
detecting an object in front of the motor vehicle during operation in the low beam mode; and
triggering, upon detection of the object, an automatic reduction of a light intensity distribution solely in a region of the low beam distribution, a size and position of which are a function of a distance of the motor vehicle from the object, from a position of the object, and from a width of the object.

2. The method according to claim 1, wherein the reduction of the light intensity distribution is triggered only when the distance of the object from the motor vehicle is less than a distance threshold value.

3. The method according to claim 1, wherein the distance threshold value is 15 meters at most or 10 meters at most.

4. The method according to claim 1, wherein the light intensity of the low beam distribution outside the region is maintained substantially simultaneously with the reduction of the light intensity distribution in the region.

5. The method according to claim 1, wherein the reduction of the light intensity distribution is triggered only when the motor vehicle is traveling at a speed below a speed threshold or is stationary.

6. The method according to claim 1, wherein the low beam distribution is designed as a city low beam distribution.

7. The method according to claim 1, wherein during the reduction of the light intensity distribution, the light intensity is set to a fixed value.

8. The method according to claim 1, wherein during the reduction of the light intensity distribution, the light intensity in the region is controlled as a function of a brightness that is determined in the region.

9. The method according to claim 1, wherein the object includes a group of multiple motor vehicles, wherein the region includes multiple sections that are separate from one another, and one motor vehicle from the group is situated in each of the sections.

10. A control unit for headlights of a motor vehicle, the control unit comprising:
an electronic digital memory medium; and
a digital signal processing unit,
wherein machine-readable instructions are stored in the memory medium, and
wherein the digital signal processing unit is designed to read out and execute the instructions, and during execution of the instructions to control the headlights by the method according to claim 1.

11. A motor vehicle that comprising at least one headlight and the control unit according to claim 10.
